(19) United States
(12) Patent Application Publication
(10) Pub. No.: US 2003/0052870 A1
(43) Pub. Date: Mar. 20, 2003

(54) Method and apparatus for sharing an external power supply between a PDA and RF wireless modem

(76) Inventors: Steven Robert Danielewicz, Calgary (CA); Richard Francis Lyne, Calgary (CA)

Correspondence Address: COUDERT BROTHERS LLP, 3rd Floor, 600 Beach Street, San Francisco, CA, 94109, US

(21) Appl. No.: 10/243,451

(22) Filed: Sep. 13, 2002

Related U.S. Application Data
(60) Provisional application No. 60/322,535, filed on Sep. 14, 2001.

(51) Int. Cl. G09G 5/00

(52) U.S. Cl. 345/204

(57) ABSTRACT

This invention comprises a method and system for powering from a single external power supply a host computing device and a modem detachably connected to the host computing device, the modem having internal modem circuitry including a modem central processing unit, an external power input jack, and a power output connector, and the host computing device including a connector that mates with the modem output connector when the modem is attached to the host computing device.

### CROSS-REFERENCE TO RELATED APPLICATIONS

This application claims the benefit of U.S. Provisional Application No. 60/322,535, filed on Sep. 14, 2001.

### FIELD OF THE INVENTION

This invention relates to data communications equipment, and more particularly to a method and apparatus for utilizing a single external supply to provide power to a radio frequency (“RF”) wireless modem and a host computing device to which the modem is attached.

### BACKGROUND OF THE INVENTION

A recent trend in both business and consumer electronics has been the acceptance and popularity of the small handheld computer, portable computer, portable computing device or personal digital assistant, all interchangeably referred to as a PDA. Information access and portability have led to many software applications that enhance the PDA and its functionality. Typically, PDAs are able to dock to a personal computer (“PC”) to synchronize, for instance, a calendar, e-mail, and an address book between the PC and the PDA. PDAs have also been used to browse the Internet with a modem that couples to a telephone line via a connector cable connected to a telephone jack.

More recently, manufacturers have enabled synchronization and Internet browsing through the use of a wireless modem. Some PDAs have wireless capability built integrally into the device itself, such as the Palm VII available from Palm Computing, Santa Clara, Calif., while other PDAs have available a wireless cradle that attaches to a wireless modem to make an integrated PDA/wireless modem package. One example of such a package is a Palm V PDA available from OmniSky of Palo Alto, Calif. combined with a Minstrel V wireless CDPD (Cellular Digital Pocket Data) modem. Another example is a Jornada™ 540 series PDA available from Hewlett Packard, Palo Alto, Calif. combined with a Minstrel 540 wireless modem.

There are many ways to attach one device to another. The most recent method is described in U.S. Pat. No. 6,115,248 to Canova, et al., dated Sep. 5, 2000, entitled “Detachable Securement of an Accessory Device to a Handheld Computer,” which describes an invention to provide for coupling an accessory device to the back face of a handheld computer while electrically connecting the accessory device to the handheld computer through a communications or output port. A benefit of the PDA and RF wireless modem combination is the fact that the combination forms a system that is truly a wireless and portable device.

One disadvantage of coupling an RF wireless modem to a PDA comes into play when a battery in the modem or a battery in the PDA (or both batteries) becomes discharged and needs to be recharged. In the prior art, the only way to charge both batteries was to have a plug-in charger or power supply for each. In some cases, the PDA and the modem can be left attached to each other during recharging, while in others, the PDA must be separated from the modem for recharging. However, all cases require two separate power supplies. For a mobile business person or for a consumer who travels a great deal, a system that requires two separate power adaptors is inconvenient. Moreover, having to frequently detach the PDA and modem units presents opportunities for the units to suffer damage.

What is needed is a low cost way to provide power to both the PDA and an attached RF wireless modem without having to detach them from each other to recharge the two devices and without having to carry two power supplies, or even one very large and heavy power supply.

### SUMMARY OF THE INVENTION

The present invention is directed at addressing the above-mentioned shortcomings, disadvantages, and problems. One embodiment of the present invention comprises a method for powering from a single external power supply a host computing device and a modem detachably connected to said host computing device, said modem comprising internal modem circuitry including a modem central processing unit, an external power input jack, and a power output connector, and said host computing device including a connector that mates with said modem output connector when said modem is attached to said host computing device, said method comprising: (a) connecting said external power supply to said modem's external power input jack; (b) coupling a first portion of power from said external power supply to internal circuitry in said modem; (c) detecting in said modem when said host computing device is connected to said modem; and (d) selectively coupling a second portion of power from said external power supply into said modem's power output connector in response to said detection, so as to power said host computing device.

The method preferably further comprises the step of causing said second portion of power from said external power supply to be decoupled from said host computing device when said modem is transmitting data generated by said host computing device.

Another embodiment of the present invention comprises a modem designed to be detachably connected to a host computing device and designed such that said modem and said host computing device are powered from a single external power supply when said modem is attached to said host computing device, said modem having internal modem circuitry, including a modem central processing unit (“CPU”), an external power input jack, an electrical connector for electrically coupling said host computing device to said modem's CPU, and an internal battery, the improvement comprising: a first internal switch coupled to said modem's external power input jack; a power output connector coupled to said first internal switch; and a first switch control coupled to said first internal switch and said modem's CPU, wherein when said external power supply is connected to said modem's external power input jack, said modem is operative for causing a first portion of power from said external power supply to be coupled to internal circuitry in said modem, and said first internal switch is operative under the control of said first switch control for causing a second portion of power from said external power supply to be selectively coupled to said modem output connector when said host computing device is connected to said modem, so as to power said host computing device.

The modem preferably further comprises a sense circuit coupled between said modem's CPU and said modem's electrical connector for detecting when said host computing device is connected to said modem. Preferably, the modem is a radio frequency wireless modem. However, in another embodiment the modem is connected to a telephone line via a connector cable. Moreover, the first internal switch is preferably a MOSFET switch. Additionally, said first internal switch is preferably further operative under the control of said first switch control for causing said second portion of power from said external power supply to be decoupled from said modem output connector when said modem is transmitting data generated by said host computing device, and said first internal switch is further operative under the control of said first switch control to be open when said host computing device is not connected to said modem.

In another embodiment of the present invention wherein said external power supply is not connected to said modem's external power input jack: said first internal switch is operative under the control of said first switch control to be open when said host computing device is not connected to said modem; and said first internal switch is further operative under the control of said first switch control to be closed when said host computing device is connected to said modem.

In another embodiment of the present invention, the modem further comprises a second switch coupled between said modem's battery and said modem's CPU and a second switch control coupled to said second switch, wherein: when said external power supply is connected to said modem's power input jack, said second switch is operative under the control of said second switch control to be open, such that said modem is powered by said external power supply; and when said external power supply is not connected to said modem's power input jack, said second switch is further operative under the control of said second switch control to be open when said host computing device is not connected to said modem, such that said modem draws no power, and is further operative to be closed when said host computing device is connected to said modem, such that said modem is powered by its internal battery.

Still another embodiment of the present invention comprises a system for powering from a single external power supply a host computing device and a modem detachably connected to said host computing device, said system comprising: (a) a host computing device; and (b) a modem designed to be detachably connected to said host computing device, said modem comprising: (1) internal modem circuitry, including a modem central processing unit (“CPU”); (2) an external power input jack coupled to said internal circuitry; (3) an internal switch coupled to said modem's external power input jack; (4) a power output connector coupled to said internal switch and to a corresponding power connector in said host computing device when said host computing device is connected to said modem; (5) a switch control coupled to said internal switch and said modem's CPU; and (6) an electrical connector coupled to said modem's CPU and a corresponding electrical connector in said host computing device when said host computing device is connected to said modem, wherein when said external power supply is connected to said modem's external power input jack, said modem is operative for causing a first portion of power from said external power supply to be coupled to internal circuitry in said modem, and said first internal switch is operative under the control of said first switch control for causing a second portion of power from said external power supply to be selectively coupled to said modem output connector when said host computing device is connected to said modem, so as to power said host computing device. The host computing device of the above system is preferably a portable personal digital assistant.

Preferably the above system is implemented using an external power supply that is rated at the sum of the maximum power draw of said host computing device and the maximum power draw of said modem while said modem is receiving. However, the system may be implemented using an external power supply that is rated at the sum of the maximum power draw of said host computing device and the maximum power draw of said modem while said modem is transmitting.

The key advantage of the present invention is that an integrated host computing device/modem system can be powered using a single external power supply.

### BRIEF DESCRIPTIONS OF THE DRAWINGS

The forgoing aspects and attendant advantages of this invention will become more readily appreciated by reference to the following detailed description, when taken in conjunction with the accompanying drawings, wherein:

FIG. 1 illustrates a perspective view of an attachable RF wireless modem according to the present invention;

FIG. 2 illustrates a front-side view of the attachable RF wireless modem according to the present invention;

FIG. 3 is a schematic illustration of the RF wireless modem of FIGS. 1 and 2 and a PDA being attached together and capable of being simultaneously powered by a single power supply in accordance with the present invention;

FIG. 4a is a block diagram illustrating an external power supply AC to DC adaptor that can be used to simultaneously power a wireless modem and PDA combination in accordance with the present invention;

FIG. 4b is a block diagram illustrating the circuitry present in an RF modem in accordance with the present invention;

FIG. 5 is a diagram illustrating the operating state of an RF Wireless modem and PDA in accordance with the present invention when they are connected but there is no external power supply connection;

FIG. 6 is a diagram illustrating the operating state of an RF Wireless modem and PDA in accordance with the present invention when they are not connected and there is no external power supply connection;

FIG. 7 is a diagram illustrating the operating state of an RF Wireless modem and PDA in accordance with the present invention when they are not connected and there is an external power supply connection;

FIG. 8 is a diagram illustrating the operating state of an RF Wireless modem and PDA in accordance with the present invention when they are connected and there is an external power supply connection but the modem is not transmitting;

FIG. 9 is a diagram illustrating the operating state of an RF Wireless modem and PDA in accordance with the present invention when they are connected and there is an external power supply connection and the modem is transmitting.

### DETAILED DESCRIPTION OF THE INVENTION

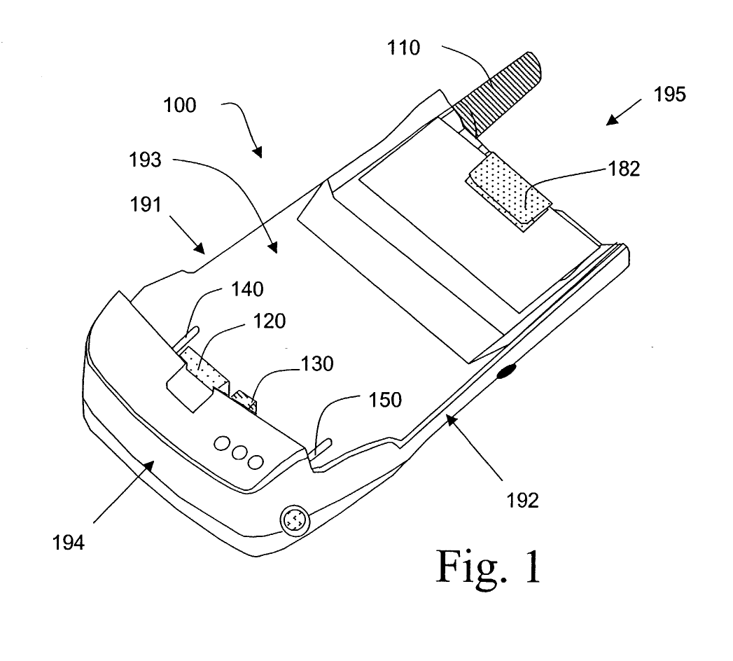

Embodiments of this invention provide for powering from a single external power supply a host computing device, e.g., a small handheld computer, a portable computer, a portable computing device or personal digital assistant, all interchangeably referred to as a PDA, and a modem detachably connected to the host computing device. FIGS. 1-9 illustrate a preferred embodiment of the present invention that comprises a modem that is a radio frequency (“RF”) wireless modem. Preferably, the wireless modem is coupled to a back-side of a PDA while an electrical coupling of the RF wireless modem connects to a corresponding electrical coupling of the PDA. The modem and PDA form a handheld wireless computing and communication device that enables the RF wireless modem to be carried with the PDA using one hand.

Those of ordinary skill in the art will recognize that the present invention can be implemented using a modem that is coupled to a telephone line via a connector cable. Moreover, other embodiments of the present invention may be implemented, wherein the host computing device is, for instance, a point of sale terminal, a vending machine, or some other conventional portable device that has an internal battery and may be detachably connected to a modem.

FIG. 1 illustrates a perspective view of an RF wireless modem 100 according to the present invention. Arrows 191, 192, 193 194, and 195 point to a left-side, right-side, front-side, bottom-side, and top-side respectively of modem 100 with a back-side not shown or labeled in FIG. 1. An antenna 110 is shown attached to top-side 195 of the modem. Guide rails 140 and 150 help align electrical connectors 120 and 130 with their corresponding connectors in a PDA. The PDA is not shown in FIG. 1. Connector 130 is a male power connector that fits into a corresponding female power connector in the PDA. A mechanical connector 182 mates with a corresponding mechanical connector on the PDA to secure the PDA and modem together.

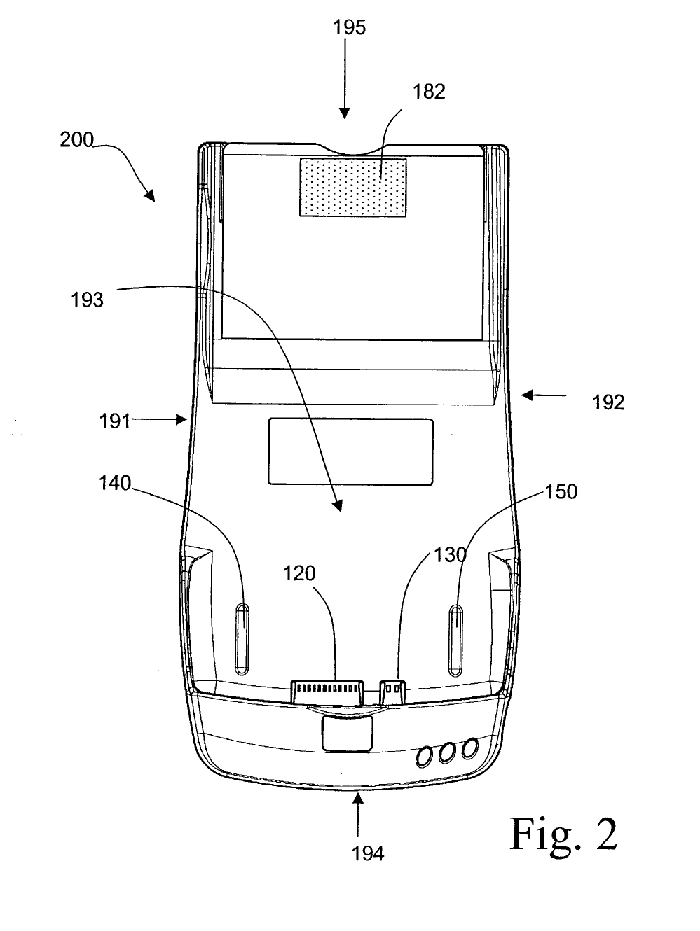

FIG. 2 illustrates a front-side view of an RF wireless modem 200 according to the present invention. Arrows 191, 192, 193 194, and 195 point to a left-side, right-side, front-side, bottom-side, and top-side respectively of modem 200 with a back-side not shown or labeled in FIG. 2. An antenna is not shown in this figure. Guide rails 140 and 150 help align electrical connectors 120 and 130 with their corresponding connectors in a PDA. The PDA is not shown in FIG. 2. A mechanical connector 182 mates with a corresponding connector on the PDA.

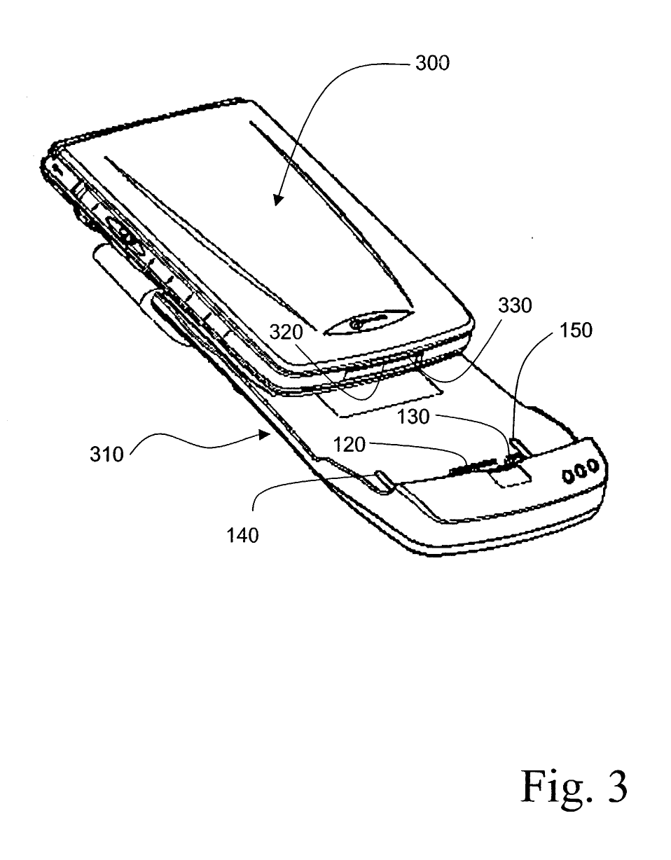

FIG. 3 is a schematic perspective view illustrating an RF wireless modem 310 and a PDA 300 being attached together and capable of being simultaneously powered by a single external power supply in accordance with the present invention. FIG. 3 illustrates that the modem and PDA are not yet securely attached in order to show the mating of electrical male connectors 120 and 130 of the modem with corresponding female connectors 320 and 330 respectively of the PDA. Connector set 130 and 330 serve as an electrical power connection from modem 310 into the PDA 300.

When powered by a single external power supply, modem 310 typically draws a maximum of 1270 milliamps while transmitting and 500 milliamps while receiving. These numbers include a maximum draw due to battery charging circuitry of 350 milliamps but will be less with a fully charged modem battery. PDA 300 typically has a maximum draw of 1500 milliamps when powered by a separate external power supply.

If we were to power both modem 310 and PDA 300 from one external power supply, we would require a maximum current draw (1270 milliamps plus 1500 milliamps) of 2770 milliamps. In one embodiment of the present invention, the modem and PDA when connected can be powered by a single external power supply that is rated at the sum of the maximum power draws of the PDA and modem. However, to minimize weight and cost, it is preferable to power both the PDA and the modem with an external power supply with a lower rating by selectively passing the external power to the PDA through the modem only when the modem is not transmitting. Accordingly, in another embodiment of the present invention, the modem and PDA when connected are powered by a single external power supply that is rated at 2000 milliamps, which is the sum of the maximum current draw of the modem while not transmitting of 500 milliamps plus the maximum current draw of the PDA of 1500 milliamps. In addition, for safety reasons, power to the external connector attached to the PDA is disconnected when the PDA is not connected to the modem to prevent having exposed voltage.

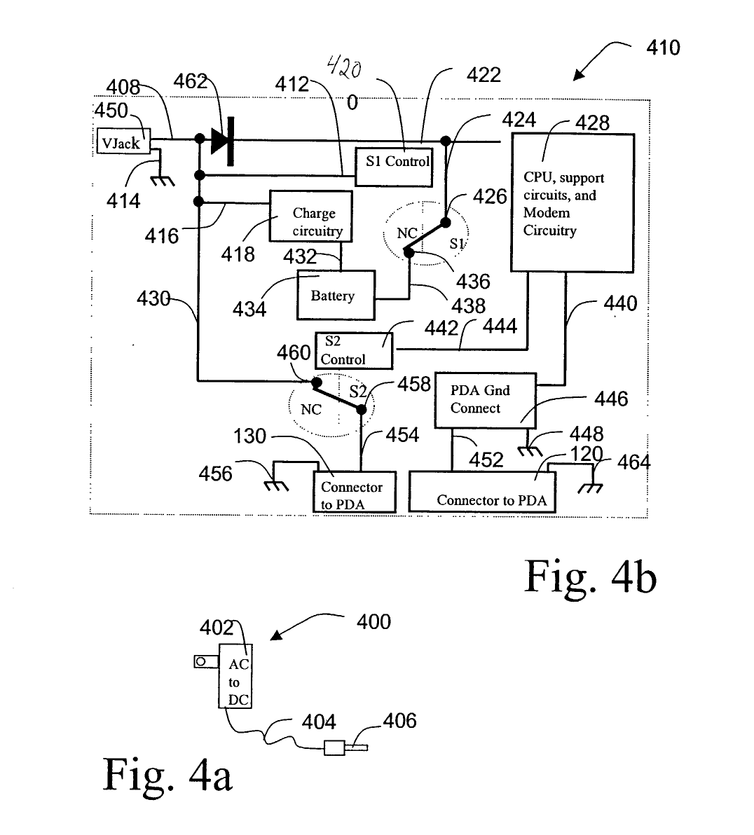

FIG. 4a is a block diagram illustrating an external power supply AC to DC adaptor 400 that can be used to simultaneously power a wireless modem and PDA combination in accordance with the present invention. Adaptor unit 402 is designed to plug into an AC outlet and produce low voltage DC power coupled through a cable 404 to a dual connector power plug 406. AC to DC power adaptors are well known in the industry. A preferred adaptor is one outputting 5 volts DC at 5% regulation and 2 amps of current with an input voltage of 120V-AC-60 Hz for operation in countries with the 120V-60 Hz power availability. One such adaptor is a model TSA-0285 available from Anoma Electric Company, LTD, Hsien, Taiwan R.O.C. or their USA company Anoma (North America) Corp., Scottsdale, Ariz.

FIG. 4b is a block diagram 410 illustrating the circuitry present in an RF wireless modem in accordance with the present invention. Plug 406 (of FIG. 4a) is designed to be inserted into a jack 450 to provide a positive voltage to a line 408, and a ground return 414 when the adaptor 402 (of FIG. 4a) is properly plugged into and powered from an AC outlet (not shown). The positive voltage applied from the adaptor is later referred to as voltage VJack in the text that follows. Voltage VJack is preferably routed through line 408 to a blocking diode 462, through a line 430 to a switch contact 460, and through a line 416 to modem charging circuitry 418. Diode 462 serves to drop voltage VJack by the junction voltage drop inherent in the diode and to preferably provide operating voltage and current to the CPU, support circuits, and modem circuitry 428 through a line 422. Voltage VJack on line 408 is also preferably sampled by a switch S1 control 420. Control 420 energizes a switch S1 contact 426 and OPENS the connection between 426 and a contact 436 preferably whenever VJack is greater than 4.5 Volts to remove a modem battery 434 output voltage and current supplied through a line 438 to contact 436 in S1. Thus when VJack is greater than 4.5 volts, battery 434 does not supply any operating power.

Charge circuitry 418 preferably provides charging current and voltage to battery 434 through a line 432 whenever VJack is greater than 4.5 volts. Whenever VJack is less than 4.5 volts, switch S1 is preferably closed so that voltage and current from battery 434 through line 438 through contact 436 and switch 426 and line 424 to line 422 may be supplied to modem circuits 428. Whenever S1 is closed, diode 462 blocks the battery voltage from communicating with the power input jack 450 and lines 408, 416, and 430.

Preferably, a PDA ground connect sense circuit 446 senses through a line 452 and a ground 448, whenever the PDA is connected through connector 120 and returns a TRUE logic level to modem circuitry 428 through a line 440. This sense circuit 446 is well known in the art and is preferably practiced by providing a small current source feeding 452 through connector 120 to a corresponding pin that is internally grounded within the PDA circuitry. When the PDA is connected, the current through 452 now has a complete path to generate a TRUE through 452 to PDA ground (not shown) back through connector from PDA ground to ground connection 464 and to corresponding ground connection 448 at the sense circuitry 446.

Electrical contact between a contact 460 on a switch S2 and a contact 458 is preferably made OPEN or CLOSED under the control of a switch S2 control 442 which communicates with the CPU 428 through a line 444. Switch S2 contact 458 is preferably connected to a line 454 which further connects to a conductor within power connector 130 that mates with a corresponding conductor pin within PDA connector 330 (illustrated in FIG. 3) to provide positive VJack voltage to the PDA upon certain conditions as practiced in the present invention, for operating the PDA and for charging its internal battery. A ground return 456 provides a ground path for power from the modem to the PDA through connector 130 on the modem and 330 on the PDA. Switches S1 and S2 are preferably implemented using standard MOSFET switches to reduce electrical interference that may effect modem operation during the transitional switching period. However other industry standard switches may be used.

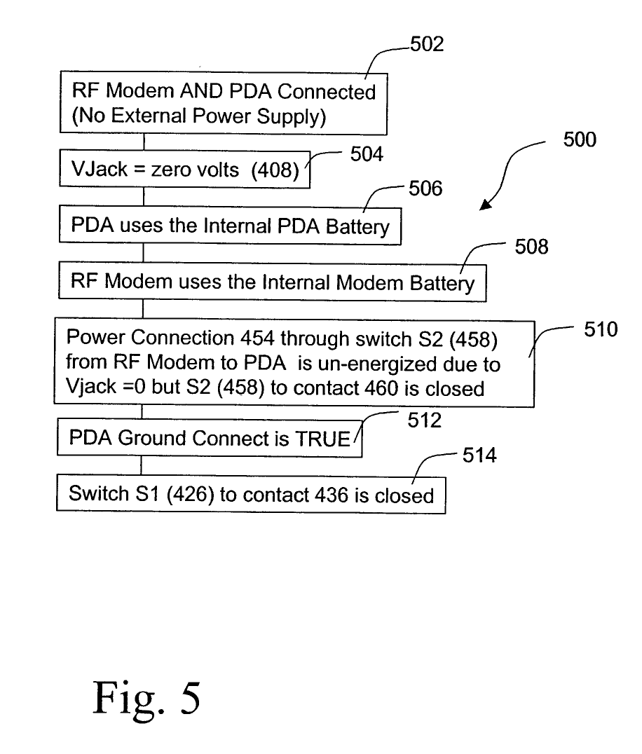

FIG. 5 is a diagram 500 illustrating the operating state of the RF wireless modem illustrated in FIG. 4b and a PDA in accordance with the present invention when they are connected but there is no external power supply connection. The state condition 502 shows that the modem and PDA are connected but have no external power supply plugged into the modem. When condition 502 is TRUE the following conditions are also present: 504, wherein VJack is zero on line 408; 506, wherein the PDA uses the internal PDA battery; 508, wherein the modem uses the internal modem battery; 510, wherein the power connection 454 through switch S2 contact 458 from the modem to the PDA is un-energized due to VJack being zero even though S2 contact 458 to contact 460 is closed; 512, wherein the PDA Ground Connect is TRUE; and 514, wherein switch S1 contact 426 to contact 436 is closed.

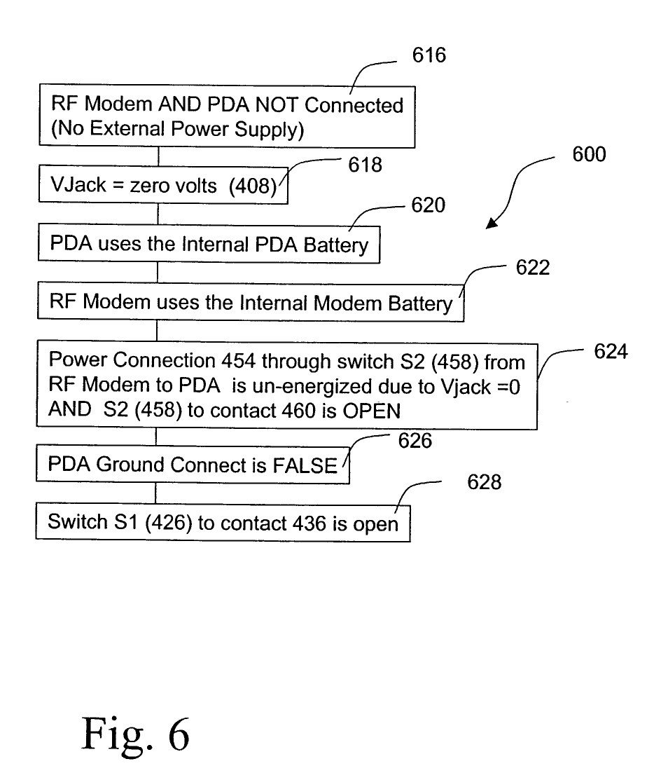

FIG. 6 is a diagram 600 illustrating the operating state of the RF wireless modem of FIG. 4b and a PDA in accordance with the present invention when they are not connected and there is no external power supply connection. The state condition 516 shows that the modem and PDA are NOT connected and have no external power supply plugged into the modem. When condition 616 is TRUE the following conditions are also present: 618, wherein VJack is zero on line 408; 620, wherein the PDA uses the internal PDA battery; 622, wherein the modem uses the internal modem battery; 624, wherein the power connection 454 through switch S2 contact 458 from the modem to the PDA is un-energized due to VJack being zero and S2 contact 458 to contact 460 is OPEN; 626, in that the PDA Ground Connect is FALSE; and 628, wherein switch S1 contact 426 to contact 436 is OPEN since there is no need to provide power to the wireless modem circuitry in this condition and the modem circuitry is removed from the battery power, to preserve battery life.

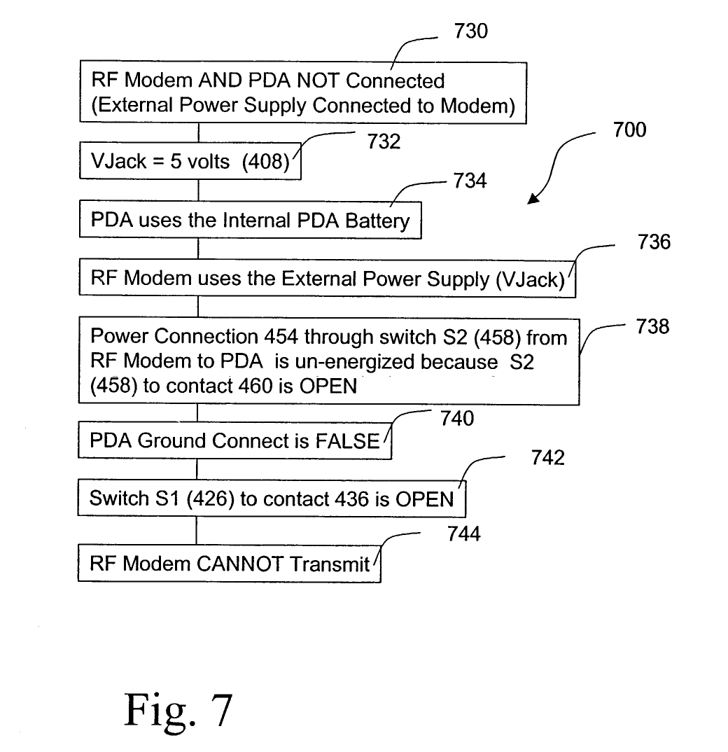

FIG. 7 is a diagram 700 illustrating the operating state of the RF wireless modem illustrated in FIG. 4b and a PDA in accordance with the present invention when they are not connected and there is an external power supply connection. The state condition 730 shows that the modem and PDA are NOT connected but an external power supply is plugged into the modem. When condition 730 is TRUE the following conditions are also present: 732, wherein VJack has 5 volts on line 408; 734, wherein the PDA uses the internal PDA battery; 736, wherein the modem uses the external power supply VJack voltage; 738, wherein the power connection 454 through switch S2 contact 458 from the modem to the PDA is unenergized even though VJack is 5 volts because S2 contact 458 to contact 460 is OPEN; 740, wherein the PDA Ground Connect is FALSE; 742, wherein switch S1 contact 426 to contact 436 is OPEN because there is no need to provide power to the modem circuitry 428 in this condition and the external power supply is used for charging the internal battery of the wireless modem; and 744, wherein the modem cannot transmit.

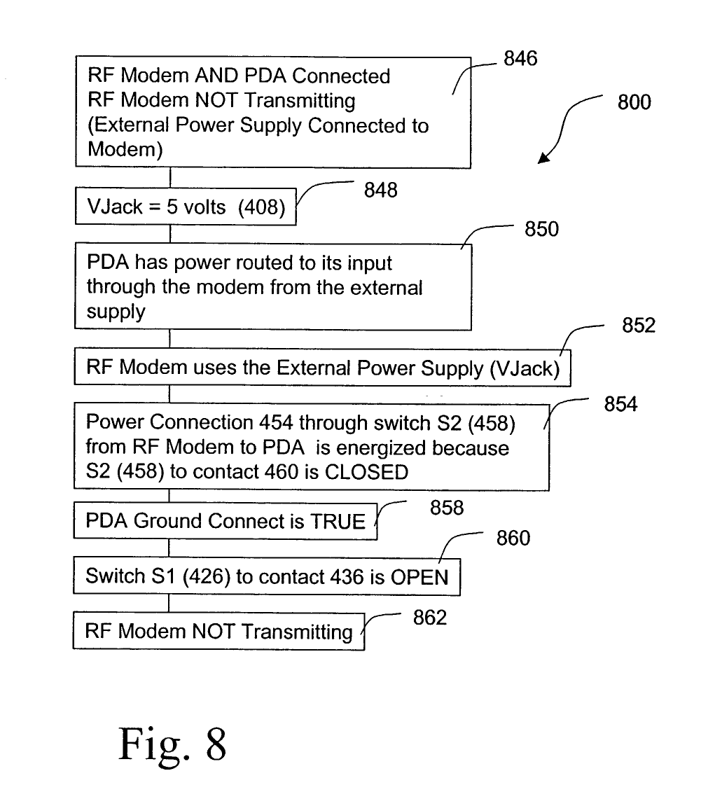

FIG. 8 is a diagram 800 illustrating the operating state of the RF wireless modem illustrated in FIG. 4b and a PDA in accordance with the present invention when they are connected and there is the external power supply connection but the modem is not transmitting. The state condition 846 shows that the modem and PDA are connected and have an external power supply plugged into the modem, but the modem is NOT transmitting. When condition 846 is TRUE the following conditions are also present: 848, wherein VJack is 5 volts on line 408; 850, wherein the PDA has power routed to its input through the modem from the external supply; 852, wherein the modem uses the external power supply VJack voltage; 854, wherein the power connection 454 through switch S2 contact 458 from the modem to the PDA is energized due to VJack being 5 volts and S2 contact 458 to contact 460 is CLOSED; 858, wherein the PDA Ground Connect is TRUE; 860, wherein switch S1 contact 426 to contact 436 is OPEN; and 862, wherein the modem is NOT transmitting.

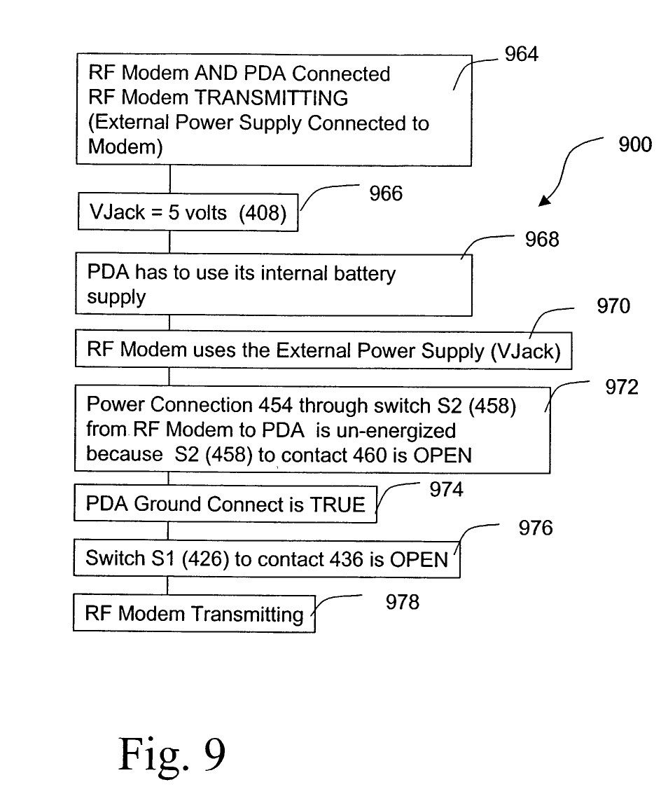

FIG. 9 is a diagram 900 illustrating the operating state of the RF wireless modem illustrated in FIG. 4b and a PDA in accordance with the present invention when they are connected and there is the external power supply connection and the modem is transmitting. The state condition 964 shows that the modem and PDA are connected and have an external power supply plugged into the modem, and the modem is transmitting. When condition 964 is TRUE the following conditions are also present: 966, wherein VJack is 5 volts on line 408; 968, wherein the PDA has to use its internal battery; 970, wherein the modem uses the external power supply VJack voltage; 972, wherein the power connection 454 through switch S2 contact 458 from the modem to the PDA is un-energized even though VJack is 5 volts because S2 contact 458 to contact 460 is OPEN; 974, wherein the PDA Ground Connect is TRUE; 976, wherein switch S1 contact 426 to contact 436 is OPEN; and 978, wherein the modem is transmitting.

The method and system for powering from a single external power supply a host computing device and a modem detachable connected to the host computing device described in the text above was chosen as being illustrative of the best mode of the present invention. All embodiments of the present invention described above are illustrative of the principles of the invention and are not intended to limit the invention to the particular embodiments described. Accordingly, while the preferred embodiment of the invention has been illustrated and described, it will be appreciated that various changes can be made therein without departing from the spirit and scope of the invention.

What is claimed is:

1. A method for powering from a single external power supply a host computing device and a modem detachably connected to said host computing device, said modem comprising internal modem circuitry including a modem central processing unit, an external power input jack, and a power output connector, and said host computing device including a connector that mates with said modem output connector when said modem is attached to said host computing device, said method comprising:
(a) connecting said external power supply to said modem's external power input jack;
(b) coupling a first portion of power from said external power supply to internal circuitry in said modem;
(c) detecting in said modem when said host computing device is connected to said modem; and
(d) selectively coupling a second portion of power from said external power supply into said modem's power output connector in response to said detection, so as to power said host computing device.

2. The method of claim 1 further comprising the step of causing said second portion of power from said external power supply to be decoupled from said host computing device when said modem is transmitting data generated by said host computing device.

3. The method of claim 1, wherein said modem is a radio frequency wireless modem.

4. The method of claim 1, wherein said modem is coupled to a telephone line via a connector cable.

5. A modem designed to be detachably connected to a host computing device and designed such that said modem and said host computing device are powered from a single external power supply when said modem is attached to said host computing device, said modem having internal modem circuitry, including a modem central processing unit (“CPU”), an external power input jack, an electrical connector for electrically coupling said host computing device to said modem's CPU, and an internal battery, the improvement comprising:
a first internal switch coupled to said modem's external power input jack;
a power output connector coupled to said first internal switch; and
a first switch control coupled to said first internal switch and said modem's CPU, wherein when said external power supply is connected to said modem's external power input jack, said modem is operative for causing a first portion of power from said external power supply to be coupled to internal circuitry in said modem, and said first internal switch is operative under the control of said first switch control for causing a second portion of power from said external power supply to be selectively coupled to said modem output connector when said host computing device is connected to said modem, so as to power said host computing device.

6. The modem of claim 5, further comprising a sense circuit coupled between said modem's CPU and said modem's electrical connector for detecting when said host computing device is connected to said modem.

7. The modem of claim 5, wherein said modem is a radio frequency wireless modem.

8. The modem of claim 5, wherein said modem is coupled to a telephone line via a connector cable.

9. The modem of claim 5, wherein said first internal switch is a MOSFET switch.

10. The modem of claim 5, wherein said first internal switch is further operative under the control of said first switch control for causing said second portion of power from said external power supply to be decoupled from said modem output connector when said modem is transmitting data generated by said host computing device.

11. The modem of claim 5, wherein said first internal switch is further operative under the control of said first switch control to be open when said host computing device is not connected to said modem.

12. The modem of claim 5, wherein when said external power supply is not connected to said modem's external power input jack:
said first internal switch is operative under the control of said first switch control to be open when said host computing device is not connected to said modem; and
said first internal switch is further operative under the control of said first switch control to be closed when said host computing device is connected to said modem.

13. The modem of claim 5 further comprising a second switch coupled between said modem's battery and said modem's CPU and a second switch control coupled to said second switch, wherein:
when said external power supply is connected to said modem's power input jack, said second switch is operative under the control of said second switch control to be open, such that said modem is powered by said external power supply; and
when said external power supply is not connected to said modem's power input jack, said second switch is further operative under the control of said second switch control to be open when said host computing device is not connected to said modem, such that said modem draws no power, and is further operative to be closed when said host computing device is connected to said modem, such that said modem is powered by its internal battery.

14. A system for powering from a single external power supply a host computing device and a modem detachably connected to said host computing device, said system comprising:
(a) a host computing device; and
(b) a modem designed to be detachably connected to said host computing device, said modem comprising:
(1) internal modem circuitry, including a modem central processing unit (“CPU”);
(2) an external power input jack coupled to said internal circuitry;
(3) an internal switch coupled to said modem's external power input jack;
(4) a power output connector coupled to said internal switch and to a corresponding power connector in said host computing device when said host computing device is connected to said modem;
(5) a switch control coupled to said internal switch and said modem's CPU; and
(6) an electrical connector coupled to said modem's CPU and a corresponding electrical connector in said host computing device when said host computing device is connected to said modem, wherein when said external power supply is connected to said modem's external power input jack, said modem is operative for causing a first portion of power from said external power supply to be coupled to internal circuitry in said modem, and said first internal switch is operative under the control of said first switch control for causing a second portion of power from said external power supply to be selectively coupled to said modem output connector when said host computing device is connected to said modem, so as to power said host computing device.

15. The system of claim 14, further comprising a sense circuit coupled between said modem's CPU and said modem's electrical connector for detecting when said host computing device is connected to said modem.

16. The system of claim 14, wherein said host computing device is a portable device.

17. The system of claim 14, wherein said host computing device is a personal digital assistant.

18. The system of claim 14, wherein said modem is a radio frequency wireless modem.

19. The system of claim 14, wherein said modem is coupled to a telephone line via a connector cable.

20. The system of claim 14, wherein said external power supply is rated at the sum of the maximum power draw of said host computing device and the maximum power draw of said modem while said modem is transmitting.

21. The system of claim 14, wherein said external power supply is rated at the sum of the maximum power draw of said host computing device and the maximum power draw of said modem while said modem is receiving.
